(19) United States
(12) Patent Application Publication
(10) Pub. No.: US 2024/0217274 A1
(43) Pub. Date: Jul. 4, 2024

(54) PNEUMATIC TIRE

(71) Applicant: BRIDGESTONE CORPORATION, Chuo-ku, Tokyo (JP)

(72) Inventor: Takashi OSAKA, Chuo-ku, Tokyo (JP)

(73) Assignee: BRIDGESTONE CORPORATION, Chuo-ku, Tokyo (JP)

(21) Appl. No.: 18/259,399

(22) PCT Filed: Oct. 28, 2021
(86) PCT No.: PCT/JP2021/039893

§ 371 Date: Jun. 27, 2023

(30) Foreign Application Priority Data
Jun. 30, 2021 (JP) 2021-109744

(51) Int. Cl. B60C 19/00

(52) U.S. Cl. CPC B60C 19/00

(57) ABSTRACT

A pneumatic tire of this disclosure includes a communication device, the communication device is entirely wrapped with a coating material, the coating material is formed of vinyl or nylon, and the communication device wrapped with the coating material is attached to a surface of a sidewall portion of the pneumatic tire or embedded in the sidewall portion.

### TECHNICAL FIELD

This disclosure relates to a pneumatic tire.

### BACKGROUND

There has been conventionally known a pneumatic tire including a communication device such as a Radio Frequency (RF) tag having a memory or the like to read and write data of manufacturing management, delivery management, usage history management, etc. of the tire (for example, see PTL 1).

### CITATION LIST

### Patent Literature

PTL 1: JP2017531825A

### SUMMARY

### Technical Problem

Communication performance of the communication device as described above might be inhibited by a tire rubber. In particular, when the tire rubber contains a high amount of carbon black, the communication performance is likely to be inhibited. Waterproof measures are also important for the communication device because it has electronic components such as an IC chip.

It could be helpful to provide a pneumatic tire including a communication device with inhibition of communication performance reduced and waterproof measures applied.

### Solution to Problem

We provide:
(1) a pneumatic tire including a communication device, wherein
   the communication device is entirely wrapped with a coating material,
   the coating material is formed of vinyl or nylon, and
   the communication device wrapped with the coating material is attached to a surface of a sidewall portion of the pneumatic tire or embedded in the sidewall portion.

### Advantageous Effect

This disclosure can provide a pneumatic tire including a communication device with inhibition of communication performance reduced and waterproof measures applied.

### BRIEF DESCRIPTION OF THE DRAWINGS

In the accompanying drawings:

FIG. 1 is a schematic tire width direction cross-sectional view of a pneumatic tire according to one of the disclosed embodiments;

FIG. 2 is a schematic view of a communication device wrapped with a coating material in the embodiment of FIG. 1; and

FIG. 3 is a schematic view of a communication device doubly wrapped with a coating material.

### DETAILED DESCRIPTION

Hereinafter, embodiments of the present disclosure will be illustratively described in detail with reference to the drawings.

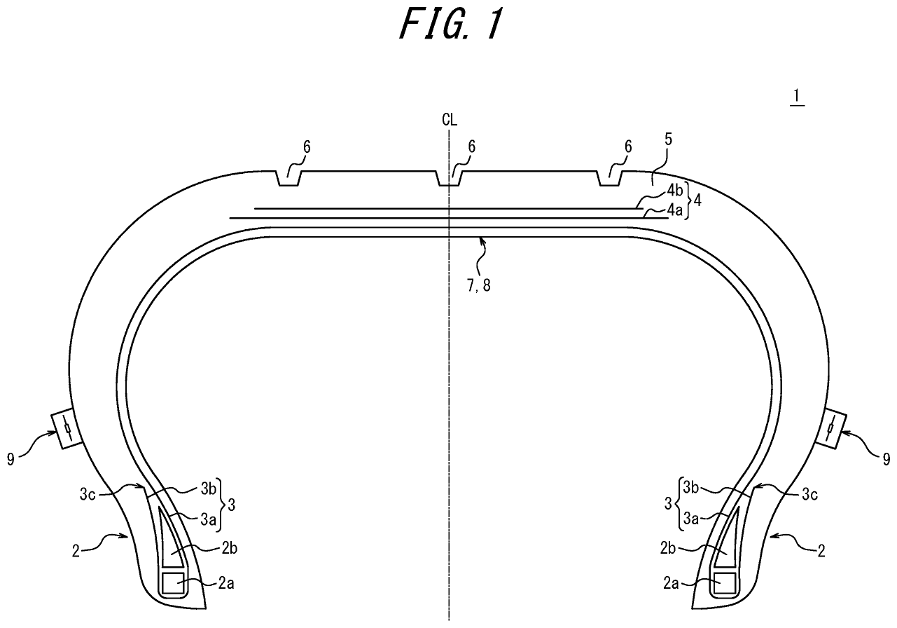

FIG. 1 is a tire width direction cross-sectional view of a pneumatic tire according to one of the disclosed embodiments. As illustrated in FIG. 1, this tire 1 includes: a pair of bead portions 2; a carcass 3 toroidally extending between the pair of bead portions 2; a belt 4 formed by one or more belt layers disposed outward in the tire radial direction of a crown portion of the carcass 3; and a tread 5 disposed outward in the tire radial direction of the belt 4.

In the illustrated example, a bead core 2a is embedded in the bead portion 2, and a bead filler 2b having a substantially triangular cross section is disposed outward in the tire radial direction of the bead core 2a.

In the illustrated example, the carcass 3 is composed of one or more carcass plies. The carcass 3 includes a carcass main body 3a toroidally extending between the pair of bead portions 2, and a carcass turn-up portion 3b that continues from the carcass main body 3a and turns up around the bead core 2a. In the illustrated example, the end of the carcass turn-up portion 3b terminates outward in the tire radial direction with respect to the outward end in the tire radial direction of the bead filler 2b, but the position of the end of the carcass turn-up portion 3b is not limited to this. The cord of the carcass ply is not particularly limited but may be an organic fiber cord.

In the illustrated example, the belt 4 includes two belt layers 4a and 4b and is an inclined belt in which belt cords extend so as to intersect one another between the layers. The angle with respect to the tire circumferential direction of belt cord is not particularly limited but may be, for example, 150 to 60°. The number of layers of the belt layer is not particularly limited so long as there are one or more layers. The material of the belt cord is not particularly limited, and a steel cord may be used.

In the illustrated example, the tread 5 is formed of a single-layer tread rubber but may be formed as a tread having a multi-layer rubber in the tire radial direction or the tire width direction. In the illustrated example, three circumferential main grooves 6 are provided on the tread 5, but the number of the circumferential main grooves, the groove width, the groove depth, the groove shape, etc. are not particularly limited.

In the illustrated example, an inner liner 8 is disposed on a tire inner surface 7. This can prevent the permeation of air and gas.

As illustrated in FIG. 1, this tire 1 includes communication devices 9 one by one at each tire width direction half bounded by a tire equatorial plane CL. The tire 1 may include one or more communication devices 9.

The communication device 9 performs wireless communication. In the illustrated example, the communication device 9 is an RF tag having: one or more (two in the illustrated example) antennas 11 that transmit and/or receive an electromagnetic wave; and an IC chip 10 that has a storage.

In this example, the IC chip 10 has any known memory, the storage and any known processor, a controller. The antenna 11 is connected to the IC chip 10 and extends linearly, wavily, or helicoidally. In this example, two antennas 11 are extending in opposite directions one another. The IC chip 10 may be operated by a dielectric electromotive force generated by the electromagnetic wave received by the one or more antennas 11. That is, the communication device 9 may be a passive communication device. Alternatively, the communication device 9 may further include a battery to allow communication by generating an electromagnetic wave with its own electric power. That is, the communication device 9 may be an active communication device. The communication device 9 can read data of manufacturing management, delivery management, usage history management, etc. of the tire, which has been stored in the storage, or write such data in the storage.

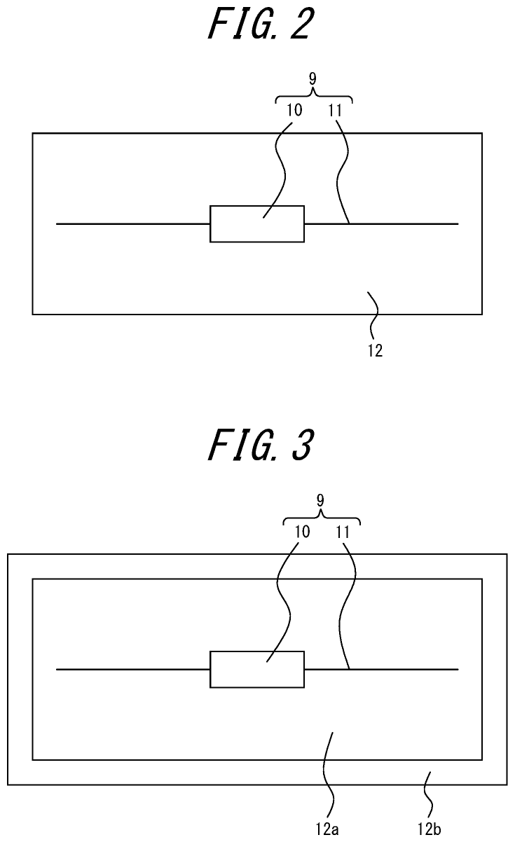

FIG. 2 is a schematic view of the communication device. The communication device 9 is entirely wrapped with a coating material 12. That is, the coating material 12 prevents the communication device 9 from being exposed to rain or the like. The coating material 12 is formed of vinyl or nylon. In the illustrated example, the coating material 12 has one layer.

As illustrated in FIG. 1, the communication device 9 wrapped with the coating material 12 is disposed on a sidewall portion of the tire in this embodiment. In this embodiment, the communication device 9 wrapped with the coating material 12 is attached to the surface of the sidewall portion of the tire 1. In this example, the communication device 9 wrapped with the coating material 12 is attached to the surface of the sidewall portion via an adhesion layer (not illustrated). Any known adhesive can be used for the adhesion layer.

As another example, the communication device 9 wrapped with the coating material 12 may be embedded in the sidewall portion.

In this example, the communication device 9 is positioned outward in the tire radial direction with respect to the end of the carcass turn-up portion 3b but is positioned inward in the tire radial direction with respect to a tire maximum width portion (part where the tire width in the tire width direction is maximum in a cross sectional view of FIG. 1). This can cause the carcass to reduce inhibition of transmitting and receiving of the electromagnetic wave and can increase durability of the communication device by avoiding a part near a buttress portion where deformation is large. On the other hand, the disposition of the communication device 9 is not limited to this example. The communication device 9 may be positioned inward in the tire radial direction with respect to the end of the carcass turn-up portion 3b. The communication device 9 may be positioned outward in the tire radial direction with respect to the tire maximum width portion.

Hereinafter, operations and effects of the pneumatic tire of the present embodiment will be described.

In the pneumatic tire of this embodiment, the communication device 9 is entirely wrapped with the coating material 12 formed of vinyl or nylon. Vinyl and nylon do not prevent the electromagnetic wave compared with a rubber containing carbon black and thus can reduce inhibition of the communication performance of the communication device 9. Vinyl and nylon have waterproof property and water repellency. Thus, the communication device 9 entirely wrapped with such coating material has high waterproof property.

In this way, the pneumatic tire of this embodiment can include a communication device with inhibition of communication performance reduced and waterproof measures applied.

Furthermore, vinyl and nylon have stretchability and thus can follow the deformation of the tire and are materials having high durability.

The communication device wrapped with the coating material is preferably attached to the surface of the sidewall portion via an adhesion layer.

As illustrated in FIG. 3, the communication device 9 is preferably doubly wrapped with one type or two types of coating materials 12a and 12b. This is because the waterproof property can be ensured even if the coating material (for example, of the surface layer) is ruptured. When two types of coating materials 12a and 12b are used, for example, vinyl can be used for the inner layer 12a and nylon can be used for the outer layer 12b, or nylon can be used for the inner layer 12a and vinyl can be used for the outer layer 12b.

Although no specific limitations are placed on the pneumatic tire of this disclosure, the pneumatic tire of this disclosure is particularly suitable for a passenger vehicle tire or a tire for truck and bus.

### REFERENCE SIGNS LIST

1 tire
2 bead portion
3 carcass
4 belt
tread
6 circumferential main groove
7 tire inner surface
8 inner liner
9 communication device
10 IC chip
11 antenna
12 coating material

1. A pneumatic tire comprising a communication device, wherein
the communication device is entirely wrapped with a coating material,
the coating material is formed of vinyl or nylon, and
the communication device wrapped with the coating material is attached to a surface of a sidewall portion of the pneumatic tire or embedded in the sidewall portion.

2. The pneumatic tire according to claim 1, wherein the communication device wrapped with the coating material is attached to the surface of the sidewall portion via an adhesion layer.

3. The pneumatic tire according to claim 1, wherein the communication device is doubly wrapped with one type or two types of the coating material.

4. The pneumatic tire according to claim 1, wherein the communication device is an RF tag having: one or more antennas that transmit and/or receive an electromagnetic wave; and an IC chip that has a storage.

5. The pneumatic tire according to claim 2, wherein the communication device is doubly wrapped with one type or two types of the coating material.

6. The pneumatic tire according to claim 2, wherein the communication device is an RF tag having: one or more antennas that transmit and/or receive an electromagnetic wave; and an IC chip that has a storage.

7. The pneumatic tire according to claim 3, wherein the communication device is an RF tag having: one or more antennas that transmit and/or receive an electromagnetic wave; and an IC chip that has a storage.

8. The pneumatic tire according to claim 5, wherein the communication device is an RF tag having: one or more antennas that transmit and/or receive an electromagnetic wave; and an IC chip that has a storage.
